(19) United States
(12) Patent Application Publication
(10) Pub. No.: US 2003/0051762 A1
(43) Pub. Date: Mar. 20, 2003

(54) Bending and retaining device for tubes, cables and pipes

(76) Inventor: Peter Kessler, (US)

Correspondence Address: Baker & Daniels, Suite 800, 111 East Wayne Street, Fort Wayne, IN, 46802, US

(21) Appl. No.: 10/149,340

(22) PCT Filed: Dec. 6, 2000
(86) PCT No.: PCT/DE00/04336

(30) Foreign Application Priority Data
Dec. 13, 1999 (DE) 199 60 025.2
Sep. 5, 2000 (DE) 100 43 580.7

(51) Int. Cl. F16L 11/00

(52) U.S. Cl. 138/120; 138/155; 138/DIG. 8

(57) ABSTRACT

The invention relates to a bending and holding aid, especially for pipes, cables and lines consisting of a bendable hollow body that is closed, at least in sections, open at both front ends having a substantially tube-shaped enveloping surface, which consists of individual articulated members connected by means of connecting elements with flexible angles, where the freely accessible front ends of an articulated member form a sharp angle whose opening is oriented in the direction of the connecting elements. The bending aid is configured such that the connecting element is a defined one-dimensional joint and that on the side of the bending aid opposite the connecting elements catching elements are disposed that connect the adjacent articulated members so as to interlock, without additional holding device, when the bending aid is bent.

This invention provides an aid for shaping and mounting pipes which allows approximately uniform shaping in free bending and the obtained curvature is ensured even when external influences change.

The invention relates to a bending and holding aid, especially for pipes, cables and lines consisting of a bendable hollow body that is closed, at least in sections, open at both front ends having a substantially tube-shaped enveloping surface, which consists of individual articulated members connected by means of connecting elements with flexible angles, where the freely accessible front ends of an articulated member form a sharp angle whose opening is oriented in the direction of the connecting elements.

DE 39 25 171 A1 specifies a pipe holding device, which is a bendable, longish, sleeve-type body, open on both sides and provided with V-shaped sections. With this, bent lines or pipes can be fixed in position if a cable binder or wire through the eyelets of the end members, for example, holds the formed radius. In order to install the line the preformed sleeve-type body is opened and closed.

When pipes and lines are installed, line guides are often required to obtain small radii. At the same time, they should not change their position under external or internal influences, such as temperature. For fast, cost-effective mounting, lines with thin walls and a small cross-section are often freely bent, for example when they are installed. For special applications, such as floor installed lines to be guided upward along a heating element, particularly small radii are required for floors with low structure.

When pipes are installed in wall slots, angle fittings have to be installed because of otherwise large slot radii. This is disadvantageous due to high costs and the risk of leaks.

When cables or cable harnesses are installed, for example in machines or vehicles, the cables or cable harnesses have to be mounted or guided by means of expensive winding bands in the critical places so as to guide them properly.

Therefore, the aim of this invention is to develop an aid for shaping and holding pipes, lines and cables allowing an approximately uniform shape when freely bent and ensuring the obtained curvature even when outside influences, such as the temperature change. It should be easy to manufacture and mount.

This problem is solved by means of the features of the main claim. The bending and holding aid is configured such that the connecting element is a defined one-dimensional joint and that catching elements are disposed on the side of the bending and holding aid opposite the connecting elements, which connect the respective adjacent articulated members so as to interlock when the bending and holding aid is bent.

During the installation, the aid is pushed over the pipe or the line to be bent up to the bending place. The constant inside diameter of the articulated members is larger than the outside diameter of the pipe. The aid is oriented such that the connecting elements are on the bending plane and the assumed joint axes are disposed normally relative to the connecting elements. When the free pipe ends are bent in the direction of the bending center point relative to the pipe in that a force is applied to the center of the aid, the pipe pulls the aid along. The force applied to the pipe in the area of the bend is distributed over a larger area than in common free bending. This prevents the risk of denting or breaking the pipe. Therefore, it is easier to bend smaller radii than with common free bending.

In bent state, the individual articulated members are automatically interlocked and ensure a permanent position for the bent pipe or line. Due to the difference in diameter between the outside diameter of the pipe and the inside diameter of the aid small deformations of the pipe within the clearance are possible.

In bent state, the aid is longer than the curve length of the pipe. Therefore, the entire curve is guided and evenly bent. In bent state, the pipe and the aid can form a sharp angle at the ends of the device, i.e. with a quarter bend, the pipe is bent by precisely 90°, while the bending angle of the aid is 88°, for example.

The aid also serves to protect the pipe or line from external damage in the bent area. Pipes made of metal, plastic or a composite material, for example, can be bent and guided in the aid, but the aid can also be used purely as a guiding device, for example for hoses and flexible electrical lines. The maximum bending angle of the pipe is limited by the contact between the front ends of two adjacent articulated members. This prevents that the pipe is bent excessively. The catching device locks before the front ends come into contact. Then, a small clearance remains between the articulated members, for example, as a result of the undercut of the self-locking catching device.

The bending direction of the aid is prescribed by the connecting element of the articulated members. Its moment of resistance against bending is lower in the direction of the articulated member than in transverse direction.

Further details of the invention are included in the sub-claims and in the following description of several diagrams illustrating exemplary embodiments.

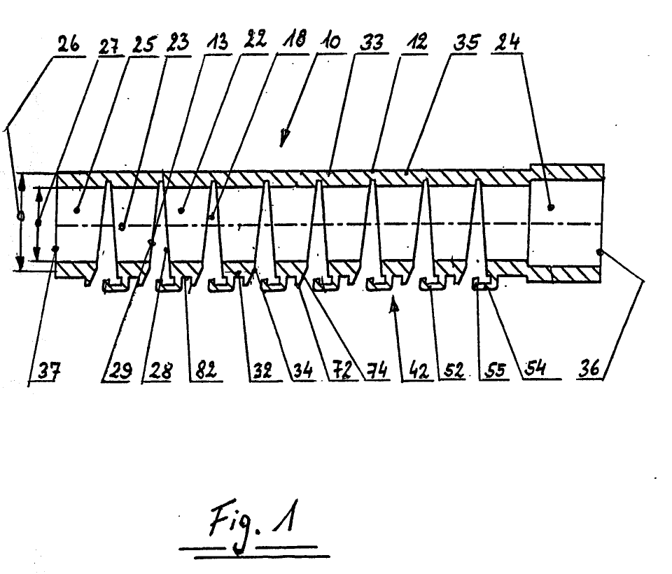

FIG. 1: longitudinal section of a bending and holding aid in stretched position;

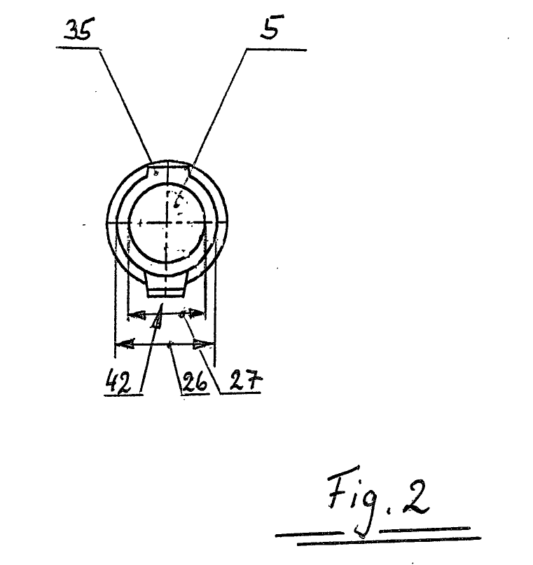

FIG. 2: front view of the aid;

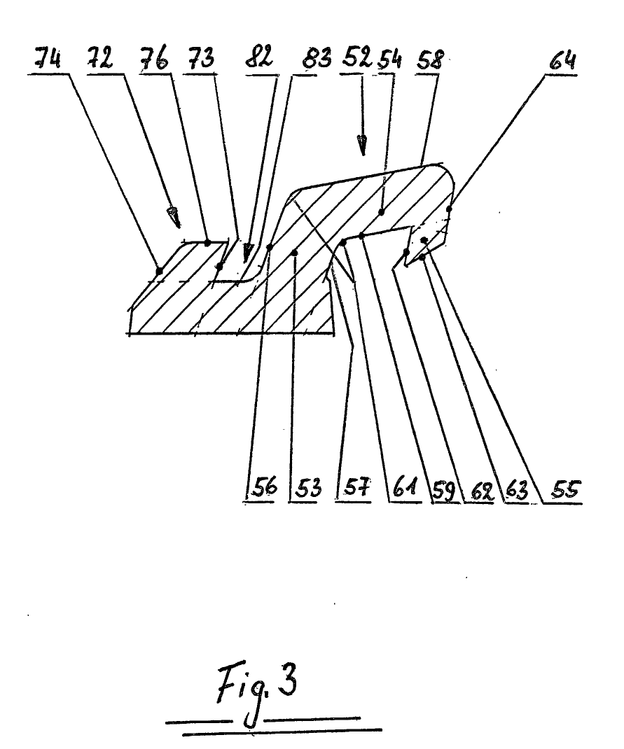

FIG. 3: a catching hook in detail;

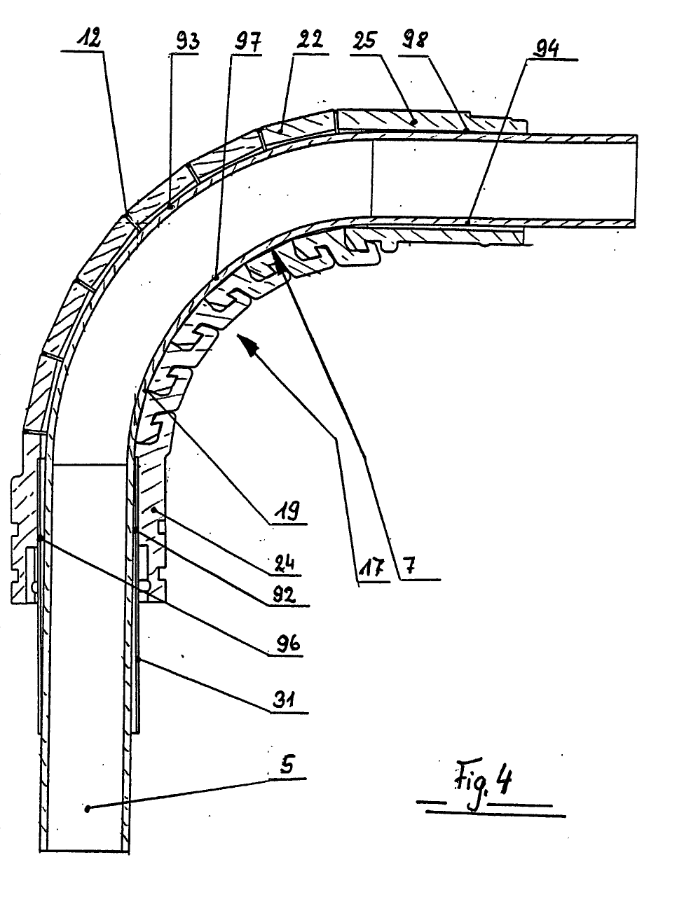

FIG. 4: installed bending and holding aid;

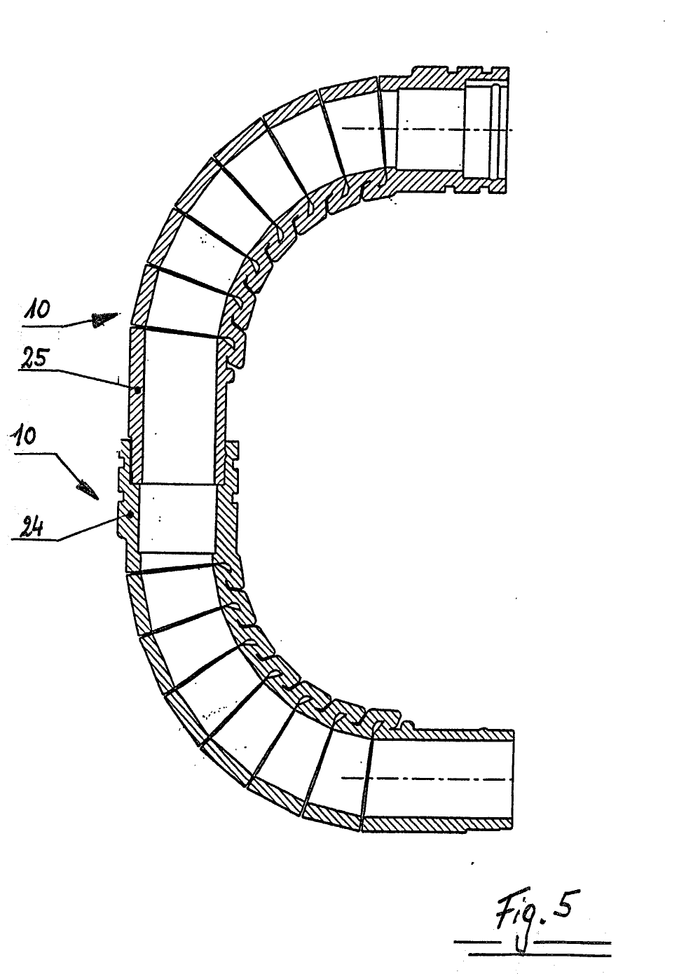

FIG. 5: combination of two bending and holding aids.

FIG. 1 is a longitudinal section of a bending and holding aid (10) in stretched position. Said bending aid (10) is a tube-shaped aid divided into articulated members (22) with clearances (18) in between. The articulated members (22) are connected by means of hinged joints (12). One of the articulated members (22) is a first member (24) and one is a last member (25). Catching devices (42) consisting of catching hooks (52) and catching projections (72) are disposed on the articulated members.

Depending on the desired radius, the bending aid (10) comprises the required articulated members (22), for example nine. These are sleeves, for example having a concentric cylindrical outside (26) and inside (27) diameter. The inside diameter (27) is approx. 70% of the outside diameter (26), for example. All articulated members (22) have an identical inside (27) and an identical outside (26) diameter, at least in sections.

The two front ends (28, 29) of each articulated member (22) form a sharp angle, thereby forming a short (32) and a long (33) lateral side, both of which are on the sectional plane of the drawing according to FIG. 1. The vertex of the angle of the front ends (28, 29) is outside the articulated member (22) on the short lateral side (32). The catching devices (42) are provided on the short lateral side (32), while on the long lateral side (33) the hinged joints (12) are disposed for connecting the individual articulated members (22).

The catching devices (42) usually consist of a catching hook (52) and a catching projection (72). The catching projection (72) pertaining to the respective catching hook (52) is located on the adjacent articulated member (22). For each articulated member (22) having an adjacent articulated member (22) on both sides, the catching hooks (52) and the catching projections (72) are disposed next to each other on the short side (32) in the longitudinal section of the bending aid (10). For the articulated members (22) that have only one adjacent articulated member (22), only one catching hook (52) and only one catching projection (72) are provided on the short side (32). The catching hook (52) (see FIG. 3) is disposed so as to be elevated above the articulated member (22) by approx. half of the length of the short lateral side (32). It consists of a vertically or diagonally upward oriented bracket (53), an approximately horizontally oriented arm (54) and a hook (55) oriented in the direction of the articulated member (22). The catching hook (52) is oriented approximately parallel with the short lateral side (32) projecting on the front end (28) over the short lateral side (32) in one direction by approximately half of the length of the short lateral side (32).

In the longitudinal section according to FIG. 3, the bracket (53) has two flanks (56, 57). They are oriented in the same direction as the clearance (82). The two flanks (56, 57) are parallel, at least in sections. In the longitudinal section, the left flank (56) in FIG. 3 changes over into the base of the clearance (83) at a radius. The right flank (57) changes over to the front end (28) of the articulated member (22) with a transitional notch.

The arm (54) is connected to the bracket (53). The arm (54) is approximately cuboid and has approximately the same material thickness as the bracket (53), and it is disposed at an obtuse or right angle to the bracket (53). Therefore, the arm (54) is at a sharp angle or parallel outward oriented relative to the center line (23) of the articulated member (22), for example. The top (58) and bottom (59) of the arm (54) change over in bevels (61) to the flanks (56, 57) of the bracket (53). The length of the arm (54) corresponds approximately to the length of the bracket (53). The hook (55) is disposed on the end of the arm (54) opposite the bracket (53). In longitudinal section, this is a trapezoid projection whose base (62) is disposed at a sharp angle to the arm (54). This angle can also be provided with a relief notch. The length of the base (62) and the height of the trapeze are approximately equal. The flank (63) of the trapeze, which is oriented to the articulated member (22), is disposed at a sharp angle with the base (62), but also at a sharp angle with the center line (23) of the articulated member (22). The height of the trapeze corresponds to approx. 90% of the width of the clearance (82).

The width of the catching hook (52) is approx. one third of the outside diameter of the bending aid (10). On the flank (56) of the bracket (53) a recess can be disposed, for example, where a tool can engage so as to lift the adjacent catching hook (52).

The catching projection (72) projects out of the short lateral side (32) by approx. one quarter of the length of the short lateral side (32). On the front end (29), the projection changes over to the bevel (34) at 50°. The length of the projection is approx. one fifth of the length of the short lateral side (32).

In longitudinal section, the catching projection (72) (see FIG. 3) is a trapeze diagonally oriented in the direction of the catching hook (52) whose left flank (74) forms a lesser angle with the horizontal line than the right flank (73). The height of the trapeze corresponds to approx. 85% of the length of the top (76). The transition from the left flank (74) to the top (76) is configured as a radius. The right flank (73) of the catching projection (72) is also a side of the clearance (82). The right flank (73) and the base of the clearance (83) form a sharp angle. Said angle can be provided with a relief notch.

The width of the catching projection (72) is approx. one third of the outside diameter of the bending aid (10).

Between the catching hook (52) and the catching projection (72) a clearance (82) is disposed, which has approximately the counter-contour of the hook (55).

On the hinged joints (12) connecting the articulated members (22) (see FIG. 1), the max. wall thickness of the bending aid (10) is approx. half as thick as in the area of the articulated members (22). The outside of the hinged joints (12) changes over to the outside of the articulated members (22), which, in continuation of the hinged joints (12) form a bridge (35) on the long lateral side (33) (see FIG. 2).

All articulated members (22) of the bending aid (10) are configured identically, except for the first (24) and the last (25) member. All catching hooks (52) point in the same direction, for example in the direction of the last member (25). Accordingly, the first member (24) has only one catching hook (52) and the last member (25) has only one catching projection (72). On the first (24) and last (25) members the front end (36, 37) representing a free end is oriented normally to the center line of the bending aid (10).

In the area of the long center line (23), the first member (24) is approximately three times as long as an articulated member (22). In the first third, i.e. near the adjacent articulated member (22), the inside (27) and the outside (26) diameter are comparable to that of the articulated members (22). In the remaining area of the first member (24), the inside diameter is larger than the outside diameter of the last member (25). The wall thickness in this area is identical to that of the other articulated members (22).

When the bending aid (10) is in stretched position clearances (18) are formed between the articulated members (22), which in longitudinal section relative to the drawing plane of FIG. 1, have the shape of an isosceles triangle. The two sides of equal length are formed by the front ends (28, 29) of the adjacent articulated members (22). The bisecting line of the angle formed by said sides is vertical relative to the center line (13) of the stretched bending aid (10).

FIG. 4 shows the bending aid (10) in installed position. The aid is pushed over a pipe (5). When the pipe (5) is bent the pipe curvature follows the bending shape prescribed by the bending aid. The bridge (35) and the catching devices (42) are on a plane with the center point (7) of the bending radius of the pipe (5). The center point of the bending radius of the pipe (5) is on the side of the catching devices (42). When it bends, the pipe (5), in the area of the center articulated members (22), lies against the bearing surface (93) on the side of the bridge (35), for example, and on the first (24) and last (25) members it lies against the bearing surfaces (92, 94) on the side of the catching devices (42). The front ends (28, 29) of the individual articulated members (22) converge and because of the varying slopes of the flanks (63, 76) the catching hooks (52) are pushed over the catching projections (72) under elastic deformation, where they interlock in that the hook (55) lies against the side (73) of the projection (72) facing the clearance (82). The undercutting of the hook ensures a firm seat. The clearances (18) between the articulated members (22) are thereby reduced to the clearances (19). In bending further, the front ends (28, 29) of the adjacent articulated members (22) come in contact and thus restrict the bending. In order to interlock the catching devices (42), the pipe (5) was bent further than required for the installed position. When the pipe (5) is released, it springs back because of its elasticity. Said spring-back movement is restricted by the catching device (42) of the bending aid (10). The undercutting of the hooks (55) ensures a firm seat.

After the pipe (5) springs back, it lies against three places, for example, on the bending aid (10) in installed position. On the first member (24), it lies against the surface (96) on the side of the hinged joint (12), in the area of the center articulated members (22) against the surface (97) on the side of the catching devices (42) and on the last member (25) against the surface (98) on the side of the hinged joints (12). In the first (24), and, if applicable, in the last member (25), the bearing surface (96, 98) of the pipe (5) is disposed on the outside point of the smaller inside diameter of the bending aid (10). The bending aid (10) is longer by approx. two pipe diameters than the curve length of the pipe curve. The bending radius of the bending aid (10) is smaller than the bending radius of the pipe (5) so as to hold the pipe (5) in its position.

The inside diameter of the bending aid (10) is 10% larger, for example, than the outside diameter of the pipe (5). In order to bend the pipe (5) by a curve of 90°, for example, the center lines (23) of the first (24) and the last (25) members of a nine-part bending device (10), for example, form an angle of 88°. In FIG. 4, the ninth part is a thin-walled protecting pipe (31) inserted into the first member (24).

The required bending radius of the bending aid (10) depends on the selected curvature of the pipe (5), on the ratio between the curve length of the pipe (5) and the length of the bending aid (10), and on the ratio between the inside diameter of the bending aid (10) and the outside diameter of the pipe (5).

If a higher curvature is selected than in the above embodiment, for example, a smaller bending radius has to be selected for the bending aid (10) while the other dimensions of the bending aid (10) remain the same. The angle formed by the front ends (28, 29) of the articulated members (22) increases.

FIG. 5 shows the connection of two identical bending aids (10) so as to achieve a bending angle of 180°, for example. The two bending aids (10) are connected in stretched position directly or by means of at least one intermediate ring. If the pipe ends are bent in the direction of the catching devices (42) the pipe (5) rests against the side of the hinged joints (12) near the connection between the two bending aids (10). On the first (24) and the last (25) members of the combined bending aids (10), the pipe (5) lies against the side of the catching devices (42). During bending, the front ends (28, 29) of the articulated members (22) converge until the catching devices (42) interlock.

The curve can also be produced without a straight intermediate part. In this case, the bending aid has a higher number of members so as to achieve direct 180° guidance.

It is also possible to bend the 90° curves separately and consecutively. In this case, the bending process corresponds to that described under FIG. 4, but after being released, the pipe will settle as described under FIG. 5.

When the bending aid (10) is used the load applied is distributed via the inside wall thickness of the bending aid over a large area on the pipe surface. The risk that the pipe (5) will break is prevented. When the bending process begins, the force introduced from the outside is distributed to the three bearing surfaces (92-94). Therefore, the area of the pipe (5) facing the bending center point (7) of the pipe (5) is able to bend without outside guidance.

The bending aid (10) can be made of plastic, for example, as an injection molded part or of metal, and other self-locking elements can also be used for the catching devices (42). Also, combinations of materials are feasible. For example, when pipes (5) are used that are difficult to bend, an additional, possibly metallic catch can be provided. It is also possible to use releasable catching devices so as to reuse the bending aid (10) when the pipes (5) are replaced, for example.

For installation, the bending aid (10) can also be provided with additional holding and mounting devices, for example. It can also be installed in or mounted on pipe guiding devices.

By means of an appropriate configuration or combination of the bending aids (10), any angles can be formed.

The tendency of the pipe to change its position as a result of its elasticity and due to temperature fluctuations, for example, is prevented by means of the locking system.

The articulated members (22) can also be provided with recesses located outside the areas of the catching devices (42). Also, the clearances (18) between the articulated members (22) can be configured such that the clearances (19) are large after the pipe (5) has been bent, where the catching devices (42) restrict the bend, for example. If there is a risk of the pipe (5) being damaged in this area, however, the clearances (19) should be small after bending.

The catching devices (42) can also be configured such that instead of the catching projections (72) grooves are provided on the articulated members (22) for engaging the catching hooks (52).

The bending aid (10) described in the exemplary embodiment has been designed for a constant radius of curvature, but the radius of curvature can also be progressive or decreasing, and options are conceivable where two or more opposite curvatures are connected.

Instead of the hinged joints (12) other one-dimensional joints can be used.

For any imaginable guided pipe or line with any desired shape, the members can be configured so as to be inserted individually and any desired direction can be achieved by means of rotating adapters, for example.

Reference list:

5 pipe

7 center point of the bending radius of 5

10 bending aid, bending and holding aid

12 hinged joint, connecting element, one-dimensional joint

13 center line

17 center point of the bending radius of 10

18 clearance

19 clearance

22 articulated member

23 center line

24 first member, articulated member

25 last member, articulated member

26 outside diameter

27 inside diameter

28 front end, front face

29 front end with bevel, front face

31 protecting pipe

32 short lateral side

33 long lateral side

34 bevel to 29

35 bridge

36 front end first member outside

37 front end last member outside

42 interlocking device, catching elements

52 catching hook

53 bracket

54 arm

55 hook

56 flank of 53

57 flank of 53

58 top of 54

59 bottom of 54

61 bevel

62 base

63 flank

72 catching projection, projection

73 flank

74 flank

76 top

82 clearance

83 basis of clearance

92 bearing surface in the first member at the beginning of the bending process

93 bearing surface in the center area at the beginning of the bending process

94 bearing surface in the last member at the beginning of the bending process

96 bearing surface in the first member at the end of the bending process

97 bearing surface in the center area at the end of the bending process

98 bearing surface in the last member at the end of the bending process

1. Bending and holding aid, especially for pipes, cables and lines consisting of a bendable hollow body that is closed, at least in sections, open at both front ends having a substantially tube-shaped enveloping surface, which consists of individual articulated members (22) connected by means of connecting elements (12) with flexible angles, where the freely accessible front ends (28, 29) of an articulated member (22) form a sharp angle whose opening is oriented in the direction of the connecting elements (12), characterized in that
the connecting element is a defined one-dimensional joint (12), and
on the side of the bending aid (10) opposite the connecting elements catching elements (42) are disposed that connect the adjacent articulated members (22) so as to interlock when the bending aid is bent.

2. Bending and holding aid as defined in claim 1, characterized in that each catching device (42) consists of at least one catching hook (52) and at least one catching projection (72).

3. Bending and holding aid as defined in claim 1, characterized in that the total width of the elements of the catching device (42) is at least one quarter of the total width of the bending aid (10).

4. Bending and holding aid as defined in claim 1, characterized in that the catching hooks (52) of all articulated members (22) are oriented in the same direction.

5. Bending and holding aid as defined in claim 1, characterized in that the catching hook (52) of an articulated member (22) has a hook (55) that engages in a clearance (82) of the adjacent articulated member (22) under elastic deformation.

6. Bending and holding aid as defined in claim 1, characterized in that the wall thickness of the bracket (53) of the catching hook (52) varies over the width of the hook.

7. Bending and holding aid as defined in claim 1, characterized in that the catching hooks (52) and projections (72) have bevels (63, 76) of varying slope in the areas coming into contact during the bending process.

8. Bending and holding aid as defined in claim 1, characterized in that the bending aid (10) comprises a first member (24) and a last member (25) where the outside diameter of the last member (25) is smaller, at least in sections, than the inside diameter in the end area of the first member (24).

9. Bending and holding aid as defined in claim 1, characterized in that sections of the front ends (28, 29) come into contact when the total bending angle is exceeded.

10. Bending and holding aid as defined in claim 1, characterized in that two or more bending aids (10) are connected so as to interlock with or without intermediate parts.

11. Bending and holding aid as defined in claim 1, characterized in that the connecting element (12) is a hinged joint.

12. Bending and holding aid as defined in claim 1, characterized in that on the bending aid (10) device additional mounting elements or mounting recesses are disposed.

13. Bending and holding aid as defined in any of the preceding claims, characterized in that at least on one end a connector transition for connecting an additional bending aid part is provided with a complementary fitting, especially an individually insertable member or a rotating adapter.
